(19) United States
(12) Patent Application Publication
(10) Pub. No.: US 2014/0044445 A1
(43) Pub. Date: Feb. 13, 2014

(54) IMAGE FORMING APPARATUS

(71) Applicant: CANON KABUSHIKI KAISHA, Tokyo (JP)

(72) Inventors: Hideo Kihara, Yokohama-shi (JP); Takuya Kitamura, Yokohama-shi (JP); Kouki Yano, Kawasaki-shi (JP)

(73) Assignee: CANON KABUSHIKI KAISHA, Tokyo (JP)

(21) Appl. No.: 13/959,989

(22) Filed: Aug. 6, 2013

(30) Foreign Application Priority Data
Aug. 10, 2012 (JP) 2012-178725

(51) Int. Cl. G03G 15/00; G03G 15/06; G03G 15/02

(52) U.S. Cl. CPC G03G 15/095
USPC 399/44; 399/50; 399/55; 399/46

(57) ABSTRACT

An image forming apparatus includes an image bearing member on which a developer image is formed, a developer bearing member configured to develop a surface of the image bearing member, and a cleaning member configured to clean a residual developer remaining on the surface of the image bearing member, wherein, when an image forming operation is interrupted, the image forming apparatus is capable of performing a recovery operation before resuming the image forming operation, and wherein the image forming apparatus is capable of, during the recovery operation, a potential difference between a potential applied to the developer bearing member and a surface potential of a non-image area within the surface of the image bearing member greater than that during the image forming operation according to a predetermined value such that the developer on the image bearing member is moved to the developer bearing member.

### BACKGROUND OF THE INVENTION

1. Field of the Invention

The present invention relates to an image forming apparatus, for example, a copying machine and a printer, having a function of forming an image on a recording material such as a sheet.

2. Description of the Related Art

Conventionally, an image forming apparatus employing an electrophotographic method generally uses a cleaning blade made of urethane rubber to remove a transfer residual toner from a surface of a photosensitive member (an image bearing member) as discussed in Japanese Patent Application Laid-Open No. 5-35156 and Japanese Patent No. 4,148,505. Such a cleaning blade (a cleaning member) presses a leading edge thereof against the rotating photosensitive member, thereby removing the toner from the surface of the photosensitive member.

In normal image formation, the amount of the transfer residual toner is approximately 10% to 20% relative to a toner image on the photosensitive member. Since the amount of the residual toner is expected to be cleaned by the cleaning blade, various settings including a blade hardness and a contact angle of the cleaning blade are set. However, in a case where a recording material is jammed, and an abnormal stop including door opening and closing occurs in the middle of a print operation, the image forming operation stops in a state that the entire toner image remains on the photosensitive member. At the time of a recovery operation, the toner image cannot be transferred due to the absence of the recording material, and the entire toner on the photosensitive member needs to be collected by the cleaning blade. Consequently, when the image forming apparatus is recovered from the abnormal stop, the larger amount of the toner is provided to the cleaning blade. Particularly, when a toner image such as a solid black image having a high printing ratio remains on the photosensitive member, there is a possibility that the cleaning blade cannot collect the entire toner, thereby allowing the toner to pass through the cleaning blade (causing cleaning failure). After passing through the blade, the toner passes a charging unit and a developing unit, and reaches the cleaning blade again. In a case where a large amount of the toner passes through the blade first, part of the toner is likely to pass through the cleaning blade again. Accordingly, the photosensitive member needs to be rotated multiple times to remove the toner therefrom. In such a case, there are concerns that a waiting time until the recovery can be prolonged, and a lifetime of the photosensitive member can be shortened. Meanwhile, the leading edge of the cleaning blade can have higher rigidity, and a contact pressure between the cleaning blade and the photosensitive member can be increased so that the cleaning blade can reliably clean the toner even if the toner remains 100% on the photosensitive member. However, such increases in the rigidity of the leading edge of the cleaning blade and the pressure against the photosensitive member may cause adverse effects such as an increase in costs and a reduction in the lifetime of the cleaning blade.

### SUMMARY OF THE INVENTION

The present invention is directed to an image forming apparatus that shortens a time needed for a recovery operation to be performed after an image forming operation is interrupted by a jam.

According to an aspect of the present invention, an image forming apparatus includes an image bearing member on which a developer image is formed, a developer bearing member configured to develop a surface of the image bearing member, and a cleaning member configured to clean a residual developer remaining on the surface of the image bearing member, wherein, when an image forming operation for forming an image on a recording material is interrupted, the image forming apparatus is capable of performing a recovery operation before resuming the image forming operation, and wherein the image forming apparatus is capable of, during the recovery operation, making a potential difference between a potential applied to the developer bearing member and a surface potential of a non-image area in which the developer image is not formed within the surface of the image bearing member greater than that during the image forming operation according to a predetermined value such that the developer on the image bearing member is moved to the developer bearing member.

Further features of the present invention will become apparent from the following description of exemplary embodiments with reference to the attached drawings.

### BRIEF DESCRIPTION OF THE DRAWINGS

FIG. 1 is a cross-sectional view illustrating a schematic configuration of an image forming apparatus according to a first exemplary embodiment of the present invention.

FIG. 2 is a cross-sectional view illustrating a schematic configuration of a cartridge according the first exemplary embodiment.

FIG. 3 is a diagram illustrating a relationship between back contrast and fogging according to the first exemplary embodiment.

FIG. 4 is a diagram illustrating a relationship between back contrast and fogging according to a second exemplary embodiment.

FIG. 5 is a diagram illustrating cleaning performance for each environment having a different absolute moisture content according to the second exemplary embodiment.

FIG. 6 is a flowchart illustrating a series of operations in a recovery operation according to the second exemplary embodiment.

### DESCRIPTION OF THE EMBODIMENTS

Various exemplary embodiments, features, and aspects of the invention will be described in detail below with reference to the drawings.

Sizes, materials, shapes and relative arrangements of components described in the exemplary embodiments can be changed as appropriate according to various conditions and a configuration of a device to which the present invention is applied. The scope of the present invention is not limited to the following exemplary embodiments.

A first exemplary embodiment of the present invention is hereinafter described.

### 1) Image Forming Unit

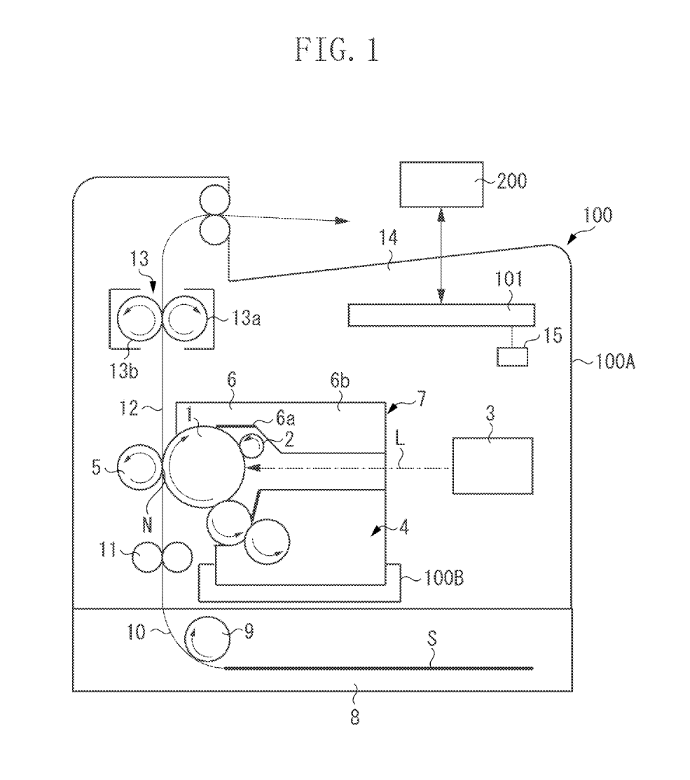

FIG. 1 is a cross-sectional view illustrating a schematic configuration of an image forming apparatus 100 according to the present exemplary embodiment.

The image forming apparatus 100 of the present exemplary embodiment is an electrophotographic laser beam printer for forming an image on a recording material S by performing a series of electrophotographic image forming processes including charging, exposing, developing, transferring, and cleaning processes on a rotatable electrophotographic photosensitive member 1 as an image bearing member. That is, the image forming apparatus 100 forms an image corresponding to an electric image signal on the recording material S, the electric image signal being input to a control circuit unit (a control unit: an engine controller) 101 of the image forming apparatus 100 from an external host device 200 such as a personal computer.

The control circuit unit 101 exchanges various information with the external host device 200. Moreover, the control circuit unit 101 comprehensively controls the entire operational sequences of the image forming apparatus 100 according to a predetermined control program and a reference table. The recording material S is a recording medium such as a recording sheet, an overhead projector (OHP) sheet, and cloth on which an image can be formed. The recording medium may be an intermediate transfer member such as an intermediate transfer drum and an intermediate transfer belt.

Moreover, the image forming apparatus 100 is a cartridge-type printer in which a process cartridge (hereinafter called a cartridge) 7 is detachably mounted on a cartridge mounting unit 100B inside an image forming apparatus body (hereinafter called an apparatus body) 100A.

In the present exemplary embodiment, a process unit for executing the series of electrophotographic image forming processes (the image forming operation) includes the drum-type electrophotographic photosensitive member (hereinafter called a drum) 1, and a contact charging member 2 serving as a charging unit for charging a surface of the drum 1. The process unit also includes an image exposure device 3 serving as an exposure device for forming an electrostatic latent image by irradiating the surface of the charged drum 1 with light. Moreover, the process unit includes a developing device 4 serving as a developing unit and a transfer roller 5 serving as a transfer unit. The developing device 4 develops and visualizes the electrostatic latent image formed (borne) on the drum 1 to a developer image (a toner image) with a developer, and the transfer roller 5 transfers the toner image to the recording material S. In addition, the process unit includes a cleaning device 6 serving as a cleaning unit for cleaning the surface of the drum 1 after the toner image is transferred from the drum 1.

The cartridge 7 in the present exemplary embodiment is an integration of the drum 1, the contact charging member 2, the developing device 4 and the cleaning device 6 as a unit out of the above components of the process unit. These components are mounted while maintaining predetermined position relationships with one another inside the cartridge 7. The cartridge 7 is inserted into and mounted on the cartridge mounting unit 100B inside the apparatus body 100A in a predetermined manner. However, the cartridge 7 can be removed from the cartridge mounting unit 100B of the apparatus body 100A in a predetermined manner.

While the cartridge 7 is mounted in a predetermined position of the cartridge mounting unit 100B, the cartridge 7 is retained and fixed to the apparatus body 100A. In the predetermined position, a drive input unit (not illustrated) of the cartridge 7 is connected to a drive output unit (not illustrated) of the apparatus body 100A. This enables a mechanical driving force to be input to the cartridge 7 from a drive source (not illustrated) of the image forming apparatus 100. Moreover, an input electrical contact (not illustrated) of the cartridge 7 is connected to an output electrical contact (not illustrated) of the image forming apparatus 100. This enables a necessary bias (voltage, potential) to be applied from a power supply unit (not illustrated) of the image forming apparatus 100 to the cartridge 7.

The drum 1 is rotationally driven at a predetermined circumferential speed (a process speed) in a direction (clockwise in FIG. 1) indicated by an arrow illustrated in FIG. 1 at predetermined control timing of an operation sequence control of the image forming apparatus 100. The contact charging member 2 charges the surface of the drum 1 by contacting the surface. In the present exemplary embodiment, the contact charging member 2 is a conductive roller (hereinafter called a charging roller) disposed in contact with the drum 1, and is rotated in a direction (counterclockwise in FIG. 1) indicated by an arrow illustrated in FIG. 1 with the rotation of the drum 1. This charging roller 2 receives a predetermined charging bias from the power supply unit (not illustrated) of the apparatus body 100A, so that the surface of the rotating drum 1 is uniformly charged with a predetermined polarity/potential (a dark portion potential). In the present exemplary embodiment, the charging bias of the predetermined potential with a negative polarity is applied to the charging roller 2, and the surface of the drum 1 is uniformly charged with a predetermined potential of the negative polarity.

The image exposure device 3, in the exemplary embodiment, is a laser beam scanner including a laser polygonal mirror lens system. The image exposure device 3 outputs a laser beam L modulated according to an image signal, so that the surface of the drum 1 uniformly charged by the charging roller 2 is irradiated and scanned with the laser beam L. This irradiation attenuates a surface potential of the irradiated area on the surface of the drum 1 to a bright portion potential (a charge is removed), and an electrostatic latent image corresponding to an image exposure pattern is formed on the surface of the drum 1 by using electrostatic contrast with the dark portion potential. This electrostatic latent image is developed as a toner image by the developing device 4 having received a developing bias. In the present exemplary embodiment, the developing device 4 is a reversal developing device employing a non-magnetic mono-component contact developing method and using a toner having a negative charge polarity as a developer. Such a developing device 4 develops the electrostatic latent image by attaching the toner to the irradiated area on the surface of the drum 1. The developing device 4 is described in detail below.

Meanwhile, the recording materials S as sheets stacked and stored inside a feeding cassette 8 are separated and fed one by one by a feeding roller 9 driven at predetermined control timing. Then, the recording material S is conveyed to a registration roller pair 11 through a sheet path 10. The registration roller pair 11 feeds the recording material S to a transfer nip portion N at predetermined control timing. The transfer nip portion N is a contact portion between the drum 1 and the transfer roller 5.

The recording material S is fed into the transfer nip portion N, and then pinched and conveyed by the transfer nip portion N. While the recording material S is being pinched and conveyed through the transfer nip portion N, a predetermined transfer bias (a polarity opposite to the charge polarity of the toner, which is a positive polarity in the present exemplary embodiment, and a voltage of a predetermined potential) is applied to the transfer roller 5 from the power supply unit (not illustrated). Accordingly, the toner images formed on the surface of the drum 1 are electrostatically transferred to the surface of the recording material S in sequence. After passing the transfer nip portion N, the recording material S is separated from the surface of the drum 1 and guided to a fixing device 13 through a sheet path 12.

The fixing device 13 is, for example, a heat-roller-type fixing device. When the recording material S is pinched and conveyed through a fixing nip portion between a fixing roller 13a and a pressing roller 13b, the fixing device 13 fixes an unfixed toner image onto the recording material S to form a fixed image using heat and pressure. The recording material S with the fixed image is discharged to a discharge unit 14 outside the apparatus. After the recording material S is separated from the surface of the drum 1 (i.e., after the toner image is transferred to the recording material S), the cleaning device 6 removes a residual toner (hereinafter called a transfer residual toner) from the surface of the drum 1 (the image bearing member). The surface of the drum 1 is cleaned by the cleaning device 6 and repeatedly used in the image forming operation.

In the present exemplary embodiment, the cleaning device 6 serving as a cleaning member is a blade-type device including an elastic cleaning blade (hereinafter called a blade) 6a made of urethane rubber. The blade 6a is disposed to face the drum 1 such that a direction from a fixed end thereof toward a leading edge as a free end is to be a counter direction with respect to a rotation direction of the drum 1. Herein, the leading edge of the blade 6a is in contact with the surface of the drum 1. The transfer residual toner on the surface of the drum 1 is scraped by the blade 6a and stored in a waste developer container 6b.

### 2) Cartridge 7

The toner stored in the developing device 4 is consumed as the image forming operation is performed. The toner is consumed until the quality of the image formed by the cartridge 7 can no longer satisfy the user who purchased the cartridge 7. Then, the cartridge 7 can be replaced by the user with respect to the apparatus body 100A.

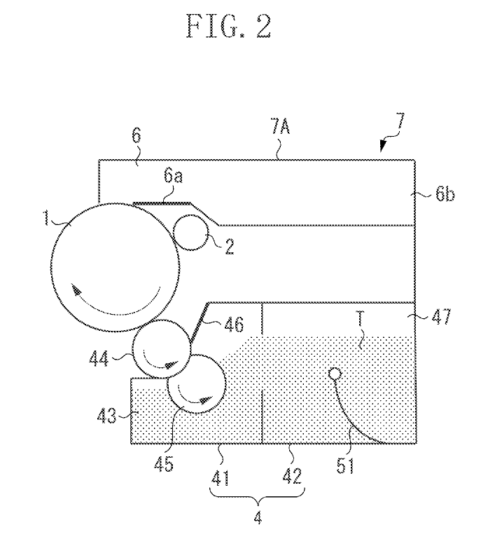

FIG. 2 is a cross-sectional view illustrating a schematic configuration of the cartridge 7.

According to the present exemplary embodiment, the cartridge 7 is integrally formed of the drum 1, the charging roller 2, the developing device 4, and the cleaning device 6 as a unit. These components are mounted while maintaining predetermined position relationships with one another inside the cartridge 7. More particularly, the cartridge 7 is formed by combining the developing device (the developing unit) 4 and a drum unit 7A including the drum 1, the charging roller 2, and the cleaning device 6 in a swingable manner.

The drum 1 and the charging roller 2 are rotatably disposed in a frame member of the drum unit 7A. The charging roller 2 is arranged parallel to the drum 1 and in contact with the drum 1 with a predetermined pressure. The drum unit 7A and the developing device 4 are urged by an urging member (not illustrated) around a combined portion (the center of rotation, not illustrated) such that the drum 1 and a developing roller 44 of the developing device 4 remain in contact with each other.

The developing device 4 is formed by combining a development frame member (a developing unit) 41 and a developer frame member (a hopper) 42. The development frame member 41 includes a development chamber 43. In the development chamber 43, the developing roller 44 is disposed in a position facing the drum 1. The developing roller 44 serves as a rotatable developer bearing member for developing the latent image formed on the drum 1 with toner. In the development chamber 43, moreover, a supply roller 45 is rotatably disposed on a side of the developing roller 44, the side being opposite from the drum 1. The supply roller 45 serves as a developer supply member for supplying the toner to the developing roller 44.

In the development chamber 43, a regulation blade 46 serving as a regulation member is also disposed. The regulation blade 46 regulates (restricts, adjusts) the amount of the toner carried by the developing roller 44, and charges the toner by contacting the developing roller 44.

The regulation blade 46 includes a base fixed to the development frame member 41. The leading edge of the regulation blade 46 elastically contacts the developing roller 44. Particularly, a front surface of the leading edge of the regulation blade 46 elastically contacts the developing roller 44 in a position at a downstream side in a developing roller rotation direction relative to a contact position between the developing roller 44 and the supply roller 45, and at an upstream side in the developing roller rotation direction relative to a facing position between the drum 1 and the developing roller 44.

The developing roller 44 is disposed parallel to the drum 1. The supply roller 45 is disposed parallel to the developing roller 44, and contacts the developing roller 44 with a predetermined pressure. The developer frame member 42 is a developer container for storing a toner T, and includes a developer containing chamber 47. The developer frame member 42 stores a predetermined initial amount of the toner T. When an agitation conveyance member 51 disposed inside the developer containing chamber 47 is rotationally driven, the toner T is sequentially supplied from the developer containing chamber 47 toward the development chamber 43.

### 3) Recovery Operation

In a case where a jam occurs (a sheet is jammed) during an image forming operation, the control circuit unit 101 interrupts the image forming operation. Subsequently, a message indicating the jam occurrence is displayed on the external host device 200 and a display unit of the image forming apparatus 100 to prompt a user to handle the jammed sheet. When the control circuit unit 101 determines that the jammed sheet is removed, the control circuit unit 101 executes a recovery operation before resuming the image forming operation. Herein, an untransferred toner image is being provided (carried) on the drum 1.

In the recovery operation, first, each of a charging bias, a developing bias, and a transfer bias is applied. Subsequently, the rotations (rotation operations) of the drum 1 and the developing device 4 are started. Herein, a negative polarity bias as the transfer bias is applied, unlike the bias to be applied during the image forming operation. This prevents the untransferred toner (the transfer residual toner) on the drum 1 from adhering to the transfer roller 5.

Next, the charging bias and the developing bias are described.

In the present exemplary embodiment, the charging bias of −900 V, and the developing bias of −300 V are being applied during a normal image forming operation. Accordingly, a surface potential Vd of the drum 1 becomes −450 V, whereas a development potential Vdc of the developing roller 44 becomes −300 V. Thus, a potential difference (hereinafter called back contrast) between these potentials Vd and Vdc is 150 V. A suitable value of the back contrast is set depending on the characteristic of the developing device 4. If the back contrast is excessively low, fogging occurs. If the back contrast is excessively high, a problem such as reversal fogging and reduction in line width occurs.

Herein, the fogging is a phenomenon in which the toner on the developing roller 44 adheres to a dark portion of the drum 1 if an electric field between the drum 1 and the developing roller 44 is weak. The reversal fogging is a phenomenon in which a reversal toner (a positive polarity in the present exemplary embodiment) generated on part of the developing roller 44 adheres to a dark portion of the drum 1. The surface potential Vd of the drum 1, in particular, is a surface potential of a non-image area in which a toner image (an electrostatic latent image) is not formed within the surface of the drum 1. Moreover, the development potential Vdc of the developing roller 44 is not only a potential (development bias) to be applied to the developing roller 44, but also a surface potential of the developing roller 44.

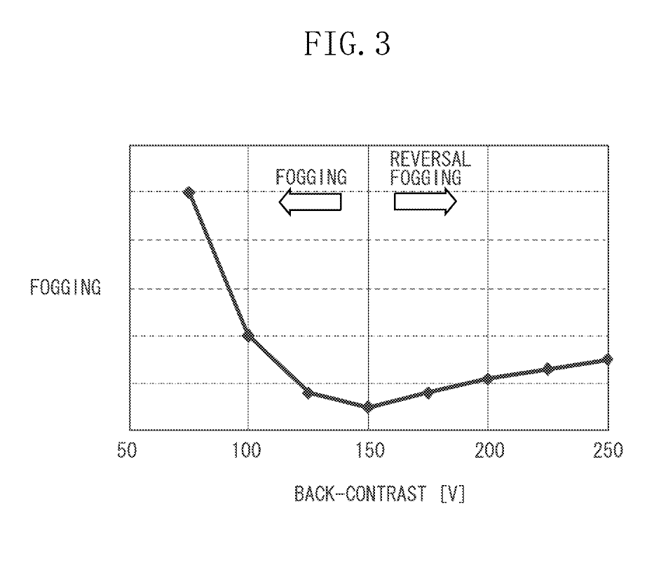

FIG. 3 is a diagram illustrating a relationship between the back contrast and the fogging according to the first exemplary embodiment. In FIG. 3, a range of the back contrast of less than 150 V is a fogging region, and a range of the back contrast of more than 150 V is a reversal fogging region.

According to the present exemplary embodiment, the charging bias is set to −950 V in the recovery operation in which image quality is not necessarily considered, so that the back contrast is set to 200 V. Consequently, the back contrast during the recovery operation is higher than that during the image forming operation. Therefore, the rotations of the drum 1 and the developing device 4 are started in a state that the back contrast is higher than that during the image forming operation. This enables the developing roller 44 to collect the transfer residual toner even if the transfer residual toner on the drum 1 passes through the blade 6a.

Hereinafter, a mechanism for collecting the toner having passed through the blade 6a by the developing roller 44 is described in detail.

The toner having passed through the blade 6a passes the charging roller 2. Herein, the charging bias is being applied to the charging roller 2, so that the surface of the drum 1 is charged to a negative polarity, and the toner on the drum 1 is also charged to the negative polarity. Since the toner charged to the negative polarity acts on the positive polarity, a force acts from the drum 1 toward the developing roller 44. Accordingly, the toner on the drum 1 is moved to the developing roller 44, and then collected by the developing roller 44.

In the present exemplary embodiment, the back contrast during the recovery operation is set to be higher than during the image forming operation, thereby increasing the strength of the electric field toward the developing roller 44 from the drum 1. Consequently, even if a large amount of the toner passes through the blade 6a, the toner can be more reliably collected by the developing roller 44. At the beginning of the recovery operation, there is the untransferred toner on the drum 1 in an area from a facing position between the drum 1 and the developing roller 44 to a facing position between the drum 1 and the transfer roller 5. Thus, the drum 1 needs to be driven for at least one rotation as the recovery operation.

According to the present exemplary embodiment, even when a large amount of the transfer residual toner on the drum 1 reaches and passes through the blade 6a during the recovery operation from an abnormal stop such as a jam occurrence, the developing roller 44 can collect the toner having passed through the blade 6a. Thus, the drum 1 does not need to be rotated for several times (several rotations) to remove the toner thereon. Consequently, the leading edge of the blade 6a does not need to have higher rigidity, or a contact pressure between the blade 6a and the drum 1 does not need to be higher.

According to the present exemplary embodiment, therefore, the time needed for the recovery operation can be shortened, and a reduction in the lifetime of the drum 1 can be suppressed without an increase in costs and a reduction in the lifetime of the cleaning blade 6.

In the present exemplary embodiment, the charging bias is changed (controlled), so that the back contrast is controlled. However, the present exemplary embodiment is not limited thereto. The developing bias may be changed to control the back contrast.

Moreover, even if the charging bias is not applied during the recovery operation, the developing bias can be changed to control the back contrast, so that the developing roller 44 can collect the toner having passed through the blade 6a during the recovery operation.

Moreover, in the present exemplary embodiment, the image forming operation is performed using the reversal developing method by which a toner is negatively charged. However, the present exemplary embodiment is not limited thereto. The image forming operation may be performed using a normal developing method by which a toner is positively charged. In such a case, a surface potential Vd of the drum 1 is a surface potential, within the surface of the drum 1, provided after the surface of the drum 1 is scanned and irradiated with the laser beam by the image exposure device 3.

A second exemplary embodiment of the present exemplary embodiment is described.

In the present exemplary embodiment, a bias in a recovery operation is controlled according to temperature and humidity near an image forming apparatus 100 (environment in which the image forming apparatus 100 is placed). In the present exemplary embodiment, components that differ from those of the first exemplary embodiment are described. The description of components similar to those in the first exemplary embodiment is omitted.

In the present exemplary embodiment, a bias setting in the recovery operation is changed according to a detection result acquired by a temperature and humidity sensor 15 at the beginning of the recovery operation. The temperature and humidity sensor 15 serves as a detection unit, and is disposed in the image forming apparatus 100.

A description is first given of a reason for changing the bias for the recovery operation according to the temperature and humidity near the image forming apparatus 100.

In a high humidity environment having a high absolute moisture content, a toner does not tend to be charged, causing a reversal toner (a positive polarity in the present exemplary embodiment) to be easily generated in one portion of the toner, on a developing roller 44, having passed a regulation blade 46. Consequently, it is not desirable that back contrast is increased in the high humidity environment in consideration of fogging.

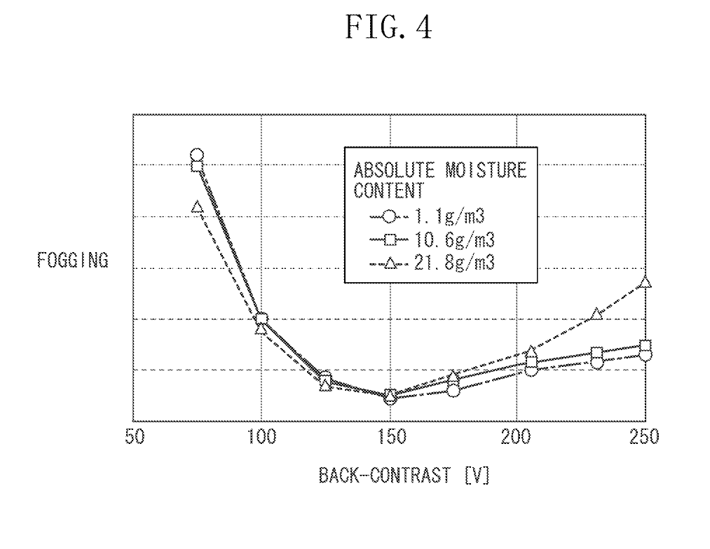

FIG. 4 is diagram illustrating a relationship between the back contrast and fogging according to the present exemplary embodiment, the relationship being measured in environments having different absolute moisture contents. As illustrated in FIG. 4, the higher the absolute moisture content, the more the reversal fogging occurs.

In the high humidity environment having a high absolute moisture content, a charge amount of a toner on a drum 1 is low as similar to that on the developing roller 44. Since the toner on the drum 1 can remain adhering to the drum 1 by reflection, a reduction in the charge amount weakens an adhesion force between the toner and the drum 1, thereby facilitating the cleaning of the toner by a blade 6a.

Therefore, when all the toner can be cleaned by the blade 6a during the recovery operation, it is desired that the back contrast be maintained at a suitable value in consideration of fogging.

Next, a setting of the back contrast for the recovery operation is described.

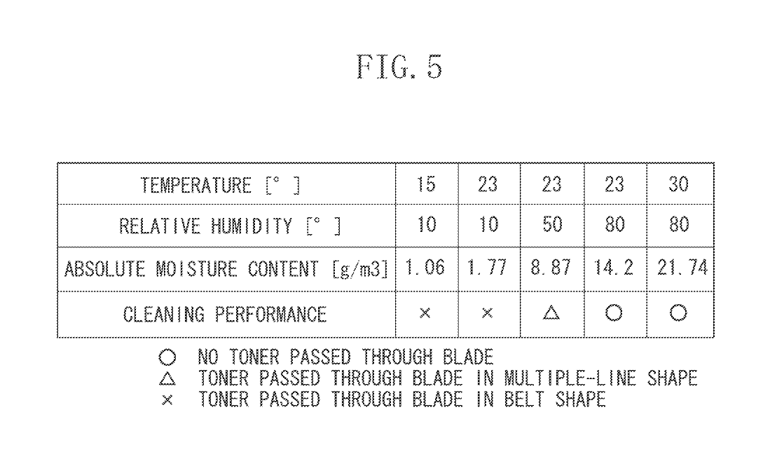

FIG. 5 is a diagram illustrating cleaning performance for each environment having a different absolute moisture content according to the present exemplary embodiment.

The cleaning performance was determined based on whether the toner passed through the blade 6a when all the toner on the drum 1 was carried to the blade 6a without transferring in the course of printing a solid black image. In the present exemplary embodiment, in the environment having an absolute moisture content of 14.20 g/m³ or greater, the untransferred toner did not pass through the blade 6a. In the environment having an absolute moisture content of less than 14.20 g/m³, the untransferred toner passed through the blade 6a.

Based on such results, in the present exemplary embodiment, if the absolute moisture content is less than 14.20 g/m³ (less than a predetermined value), the back contrast is set to 200 V to perform the recovery operation. If the absolute moisture content is 14.20 g/m³ or greater (a predetermined value or greater), the recovery operation is performed while the back contrast remains at 150 V.

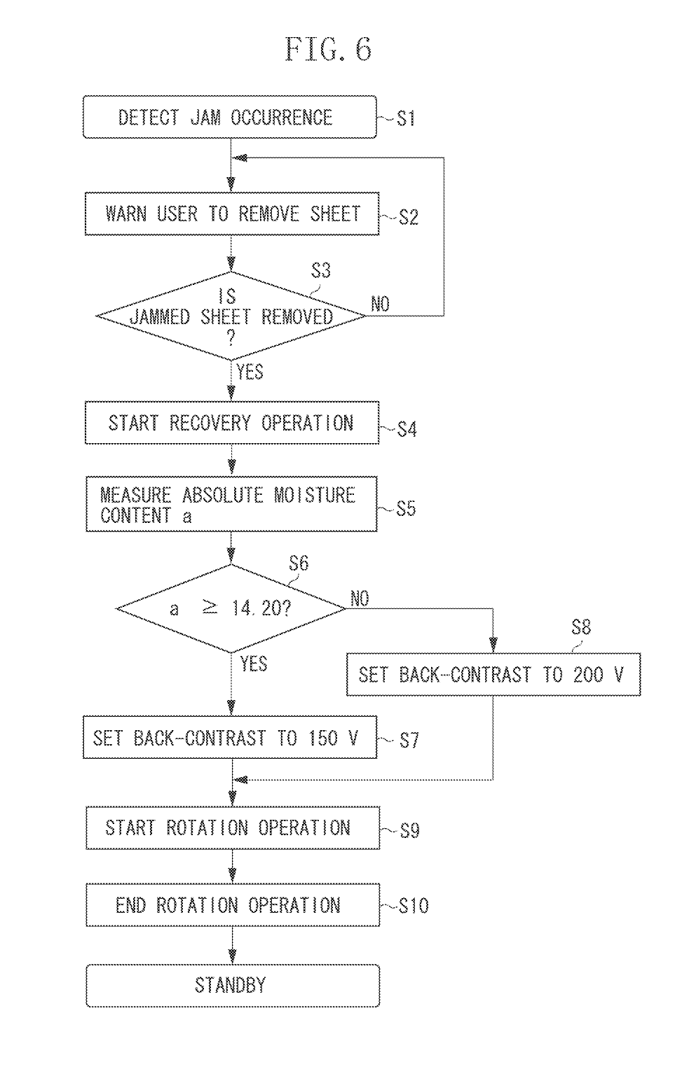

FIG. 6 is a flowchart illustrating a series of operations executed by a control circuit unit 101 in the recovery operation including the bias control.

Hereinafter, the flowchart illustrated in FIG. 6 is described.

In step S1, the control circuit unit 101 detects a jam occurrence. In step S2, upon detection of the jam occurrence, the control circuit unit 101 warns a user to remove a jammed sheet. In step S3, the control circuit unit 101 determines whether the jammed sheet is removed. If the control circuit unit 101 determines that the jammed sheet is removed (YES in step S3), then in step S4, the control circuit unit 101 starts the recovery operation. If the control circuit unit 101 determines that the jammed sheet is not removed (NO in step S3), the operation returns to step S2. In step S5, upon start of the recovery operation, the control circuit unit 101 causes an absolute moisture content “a” to be measured. In step S6, the control circuit unit 101 determines whether a≧14.20 is satisfied. If the control circuit unit 101 determines that a≧14.20 is satisfied (YES in step S6), then in step S7, the control circuit unit 101 sets the back contrast to 150 V. If the control circuit unit 101 determines that a≧14.20 is not satisfied (NO in step S6), then in step S8, the control circuit unit 101 sets the back contrast to 200 V. In step S9, when the back contrast is set, the control circuit unit 101 causes the drum 1 and a developing device 4 to start rotation operations. In step S10, when the drum 1 makes a predetermined amount of rotation (the number of rotations, angle), the control circuit unit 101 causes the drum 1 and the developing device 4 to end the rotation operations. Subsequently, the image forming apparatus 100 is set to a standby state.

According to the present exemplary embodiment, in addition to the effect described in the first exemplary embodiment, the back contrast for the recovery operation is controlled to be a suitable value according to the environment, thereby achieving an effect of reduction in waste toner consumption due to the reversal fogging.

Each of the exemplary embodiments of the present invention can shorten the time necessary to perform a recovery operation after interruption of an image forming operation due to abnormal stop such as a jam.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-178725 filed Aug. 10, 2012, which is hereby incorporated by reference herein in its entirety.

What is claimed is:

1. An image forming apparatus comprising:
a rotatable image bearing member on which an electrostatic latent image is formed;
a developer bearing member configured to develop the electrostatic latent image formed on a surface of the image bearing member with a developer into a developer image; and
a cleaning member disposed to contact the surface of the image bearing member and configured to clean a residual developer remaining on the surface of the image bearing member after the developer image on the surface of the image bearing member is transferred to a recording material,
wherein, when an image forming operation for forming an image on the recording material is interrupted, the image forming apparatus is capable of performing a recovery operation including a rotation operation of the image bearing member and an operation for applying a potential to the developer bearing member before resuming the image forming operation, and
wherein the image forming apparatus is capable of, during the recovery operation, making a potential difference between a potential applied to the developer bearing member and a surface potential of a non-image area in which the developer image is not formed within the surface of the image bearing member greater than that during the image forming operation according to a predetermined value such that the developer on the image bearing member is moved to the developer bearing member.

2. The image forming apparatus according to claim 1, further comprising a charging unit configured to charge the image bearing member,
wherein the recovery operation includes an operation for charging the image bearing member by the charging unit, and
wherein, when the recovery operation is performed, the developer on the surface of the image bearing member is charged along with the image bearing member by the charging unit.

3. The image forming apparatus according to claim 2, further comprising a control unit configured to control a potential to be applied to the charging unit such that the potential difference during the recovery operation becomes greater than that during the image forming operation.

4. The image forming apparatus according to claim 1, further comprising a control unit configured to control a potential to be applied to the developer bearing member such that the potential difference during the recovery operation becomes greater than that during the image forming operation.

5. The image forming apparatus according to claim 1, further comprising:
a detection unit configured to detect humidity in an environment in which the image forming apparatus is placed; and
a control unit configured to, if the humidity detected by the detection unit is less than a predetermined value, control the potential difference during the recovery operation to be greater than that during the image forming operation, and if the humidity detected by the detection unit is equal to or greater than the predetermined value, control the potential difference during the recovery operation to be the same as that during the image forming operation.

6. The image forming apparatus according to claim 5, wherein the predetermined value is an absolute moisture content of 14.20 g/m³.

7. The image forming apparatus according to 1, further comprising a detection unit configured to detect humidity in an environment in which the image forming apparatus is placed.

8. The image forming apparatus according to 1, wherein the potential difference is set according to a value of an absolute moisture content.

9. An image forming apparatus, comprising:
an image bearing member on which a developer image is formed;
a developer bearing member configured to develop a surface of the image bearing member; and
a cleaning member configured to clean a residual developer remaining on the surface of the image bearing member,
wherein, when an image forming operation for forming an image on a recording material is interrupted, the image forming apparatus is capable of performing a recovery operation before resuming the image forming operation, and
wherein the image forming apparatus is capable of, during the recovery operation, making a potential difference between a potential applied to the developer bearing member and a surface potential of a non-image area in which the developer image is not formed within the surface of the image bearing member greater than that during the image forming operation according to a predetermined value such that the developer on the image bearing member is moved to the developer bearing member.

10. The image forming apparatus according to claim 9, wherein the potential difference is set according to a value of an absolute moisture content.
